(19) United States
(12) Patent Application Publication
(10) Pub. No.: US 2005/0067037 A1
(43) Pub. Date: Mar. 31, 2005

(54) Collapse resistant composite riser

(75) Inventor: Mamdouh M. Salama, Richmond, TX (US)

Correspondence Address: Cheryl S. Ratcliffe;ConocoPhillips Company, P.O. Box 4783, Houston, TX, 77210-4783, US

(73) Assignee: CONOCOPHILLIPS COMPANY

(21) Appl. No.: 10/675,118

(22) Filed: Sep. 30, 2003

(51) Int. Cl. F16L 9/14; E02D 5/62

(52) U.S. Cl. 138/143; 405/224.4

(57) ABSTRACT

A composite collapse riser especially useful for deep water mineral, oil and gas exploration and production. The riser has a core with a metal liner and metal composite interfaces at each end. A reinforcing layer of dry fiber laminate, composite material or combination thereof is placed over the metal liner. Over the reinforcing layer is a shear ply layer, and over the shear ply layer is an outer main layer of composite material.

### TECHNICAL FIELD OF THE INVENTION

The present invention relates to composite risers and in particular composite risers particularly suited for deep sea mineral exploration.

### BACKGROUND OF THE INVENTION

In recent years the interest in composite risers has increased dramatically. This increased interest is a result of technical advances as well as the desire to exploit gas and oil reserves located in deeper water offshore. As the exploration and production of oil and gas move into deeper water, the weight, cost and reliability of risers have become increasingly important. These deep water applications significantly increase the pressures exerted upon the riser systems. The term “composite risers” refers to a variety of different types of high pressure pipes with metal connectors which extend from the sea bed to the surface. These risers can include but are not limited to drilling risers, production risers, workover risers, catenary risers, production tubing, choke and kill lines, as well as mud return lines.

Composite risers offer a number of advantages for deep water implementation such as high specific strength and stiffness, lightweight, corrosion resistance, high thermal insulation characteristics, high vibrational dampening and excellent fatigue performance. Additionally, composite risers can be specifically designed for each application to provide a better system oriented solution. The potential weight reduction can provide significant benefits for floating systems.

Currently, the risers predominantly in commercial use are made of steel or titanium. To achieve widespread acceptance, composite risers must show reliability equivalent or higher to the current risers. Currently, composite laminates used to make a composite riser are not fluid tight. Further, the composites have poor resistance to abrasion from drilling tools in the apparatuses used in drilling and production. Thus, the design of composite risers has included an inner liner to provide fluid integrity and/or wear resistance. Many different materials have been suggested for use as a liner, but metal liners appear to have certain advantages. Steel and titanium have been used as liners for their strength. The metal liners are relatively thin in comparison to a riser made entirely from metal.

It is important for the riser to remain fluid tight for successful operation. The integrity of composite risers is dominated by the fatigue resistance of the liner, the weld connecting the liner to the metal composite interface, the weld connecting the liner and transition ring, and the weld connecting the transition ring and metal composite interface. The failure of a weld, or other portion of the metal liner, results in a loss of pressure integrity. Thus, back-up sealing systems to maintain fluid tight passageway in composite risers have been suggested. This back-up seal is incorporated in the elastomeric liner that is placed between the metal liner and the composite structure to accommodate differential movements between the metal and the composites.

In the case where there is no back-up seal, the internal pressure will be relieved by venting to the outside of the riser if the metal liner is perforated by fatigue, wear or other damage forms. This loss of pressure containment is not operationally acceptable. But, in the case where there is a back-up seal, the internal fluids will be retained inside the riser not only inside the metal liner but also between the metal liner and the elastomeric liner. Under this condition, the pressure inside the metal liner and the pressure outside the metal liner (i.e. between the metal and the elastomeric liners) will be basically the same. However, when the internal fluids are removed during the depressurization of the riser as would be required during operations, the trapped fluid between the metal and elastomeric liners may not flow fast enough to keep a balanced pressure around the metal liner resulting in a condition where the pressure outside the metal liner is higher than the pressure inside the metal liner. In this situation, the metal liner can collapse. If the metal liner collapses, the inner bore will be reduced or blocked making it difficult to retrieve drilling tools and other equipment contained within the riser or equipment being used below the riser. In addition, it is desirable to prevent sea water from breaching the composite riser which can cause the liner to collapse.

Thus, there has been a continuing need for a lightweight collapse resistant liner. The present invention offers the advantages of improving the collapse resistance of a metal liner, with minimum additional weight.

### BRIEF DESCRIPTION OF THE DRAWINGS

The invention will be better understood with reference to the drawings taken in conjunction with the detailed description which follows. The figures are representative of preferred embodiments of the invention as follows:

FIG. 1 is a simplified cross sectional view of an embodiment of the present invention;

FIG. 2 is partial cross sectional view of one embodiment of the present invention;

FIGS. 3A, 3B, 3C, and 3D are partial side views of various embodiments of a metal liner useful in the present invention;

FIGS. 4A and 4B are cross sectional views of other various embodiments of a metal liner useful in the present invention;

FIG. 5 is a side view of an embodiment of liner having engaging sections with metal composite interfaces attached;

FIG. 6 is a partial cross sectional view illustrating one embodiment of the present invention and the shear ply; and

FIG. 7 is a partial cross sectional view illustrating another embodiment of the present invention and the shear ply.

### SUMMARY OF THE INVENTION

The invention is a collapse resistant riser especially suited for composite risers having a metal liner. The invention consists of a metal liner, a thin reinforcing layer of dry fibers or composite on the outside of the metal liner, a shear ply layer (elastomeric layer) over the reinforcing layer, and an outer main structural layer of composite material over the shear ply. In a preferred embodiment, the metal liner can have an inner performance enhancing layer which serves as a corrosion resistant layer and/or wear resistant layer positioned adjacent to the inside wall of the metal liner. Also, in a preferred embodiment, there is a fluid impermeable layer, such as rubber, over the outer main structural layer of composite. And in yet another preferred embodiment, a scuff absorbing layer, such as fiber glass composite or aramid fiber composites, is applied over the fluid impermeable layer. The preferred materials for the metal liner are steel, aluminum and titanium.

In another embodiment of the invention, the composite riser has a metal assembly having a metal liner having two ends and a metal composite interface section attached to each end. The metal composite interfaces are attached to the mechanical connector that is used to connect different riser joints to form the riser string. The mechanical connectors are a threaded oil-field connectors or flanges. The metal composite interface and the mechanical connector can be machined as one pipe from a single forging or portions can be machined separately and then welded together. A reinforcing layer of dry fiber or of composite material is applied on the outside of the liner, and a shear ply of elastomeric material (e.g. rubber) is positioned over the reinforcing layer and at least a portion of each metal composite interface. In a preferred embodiment, the composite metal interface contains one or more grooves (trap locks) for attaching the composite outer layer to the metal assembly and thus transferring the loads from the mechanical connector to the composite layer. The shear ply is covered by the outer main structural layer which is connected to the metal composite interface. In preferred embodiments, a fluid impermeable layer is provided over the outer main structural layer of composite, and a scuff resistant layer is applied over the fluid impermeable layer.

### DETAILED DESCRIPTION

The present invention will be described in relation to the expected predominant use of the composite riser which is in offshore oil and gas exploration. However, it should be understood that the invention would have application in other offshore mining techniques or in other applications where the composite riser is exposed to pressures exceeding about 1,500 psi where internal liner collapse is of concern. The use of the term “riser” is not meant to be limiting but is used in the context to describe a conduit including as described in the preferred embodiment the conduit used in offshore mineral exploration and mining.

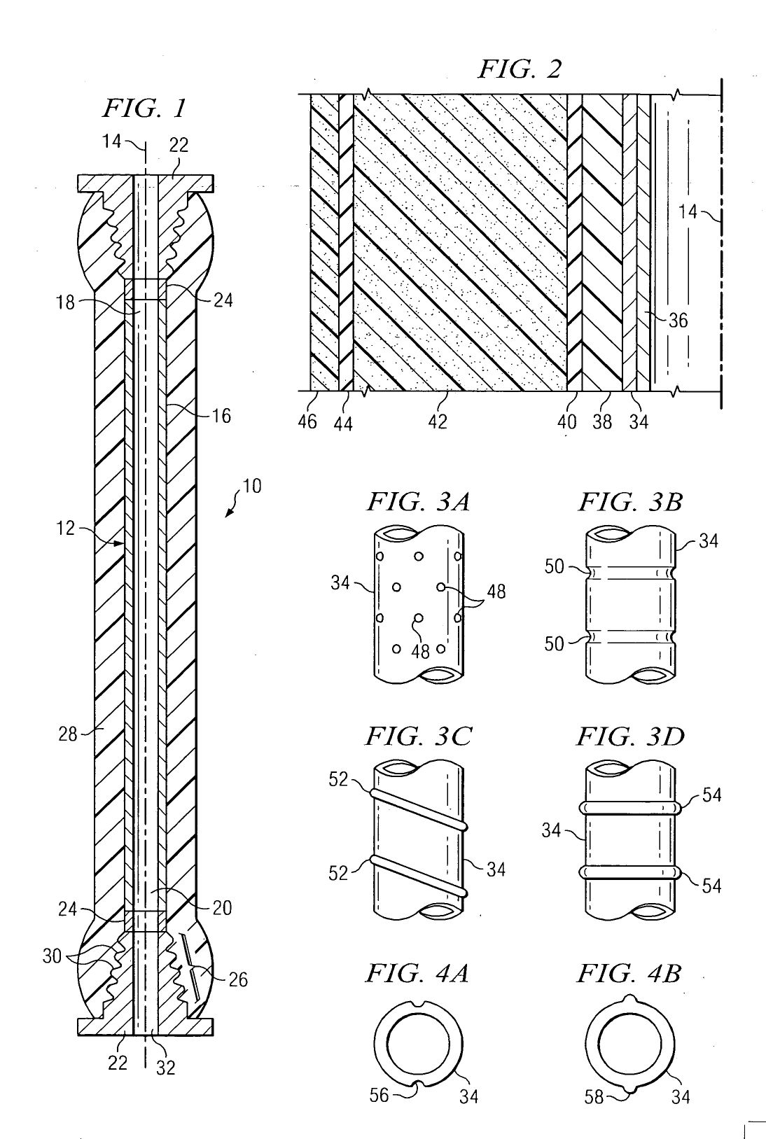

FIG. 1 is a simplified illustration of one embodiment of the present invention. Composite riser 10 has a riser core 12 which defines a longitudinal axis 14. Riser core 12 is comprised of a liner 16 having a first end 18 and a second end 20. Attached to the first and second ends of the liner are metal composite interfaces 22. These metal composite interfaces 22 may be directly attached to the liner 16 or may be attached to the liner 16 by use of a transition ring 24. The purpose of the transition ring 24 is to aid in joining liners and metal composite interfaces of different metals. In a preferred embodiment, the metal composite interface liner and the transition ring, if used, are all made of metal and the metals are sufficiently compatible to be connected by welding. The riser core 12 can be made of a single piece of metal; however, this is a less preferred embodiment due to difficulties in fabricating the core 12 in a single piece.

The metal composite interface sections 22 provide outer connecting surfaces 26 for engaging with the composite laminates 28, and attaching the composite laminates 28 to the riser core 12. The details of the construction of the composite laminates have been omitted from FIG. 1 for purposes of this illustration. The connecting surface 26 may be of any known type. In the illustrated embodiment the connecting surface 26 defines one or more trap locks 30. Connecting surface 26 can be any means to secure the composite laminates to the metal composite interface 22 section of the riser core 12. The connecting surface may include holes for receiving pins to attach the composite to the metal composite interface such as shown in U.S. Pat. No. 4,634,314 entitled “Composite Marine Riser System”. Also, the connecting surface can include a threaded surface for receiving an outer collar as shown in U.S. Pat. No. 4,875,717 entitled “End Connectors for Filament Line Tubes”. Also, the connecting surface can be a double cone shape as disclosed in U.S. Pat. No. 5,062,914 entitled “Method for Affixing a Metallic Tip to a Tube Made From a Composite Line Material”. The use of trap locks 30 is disclosed in U.S. Pat. No. 6,042,152 entitled “Interface Between Composite Tubing and End Fittings”.

A portion of the composite laminates 28 will be made of fibers impregnated with resin which are then cured. The fibers can be any of those known for use such as carbon, aramid, S-glass, E-glass, boron, or combinations thereof. These will be bound together by a polymeric resin such as an epoxy resin, or vinyl ester resin which is cured.

Once a composite material is cured, the cured resin will normally crack at a lower pressure than the fibers. Thus, in riser applications, the pressure exerted will likely be sufficient to crack the resin meaning that the composite material in the riser will not be fluid tight. The liner 16 of the riser core 12 is utilized to maintain the fluid tight integrity of passageway 32.

FIG. 2 is a partial cross-sectional view of FIG. 1 in which the details of an embodiment of the riser sheath and of the riser core of the present invention have been detailed. Metal liner 34 in a preferred embodiment has a performance enhancing layer 36 positioned on its inner surface. The performance enhancing layer 36 can be a corrosion resistant layer and/or a wear resistant layer. When the liner is made of titanium it can be desirable to provide an enhancement layer because titanium has poor wear resistance. Thus, the enhancement can be a polymeric layer or a natural rubber layer, or modified natural rubber layer. Such a layer will also provide corrosion protection. When the liner is made of steel it can be desirable to use an enhancement layer which is corrosion resistant, such as a coating of corrosion resistant metals such as chrome, nickel, etc. An internal liner of hydrogenated acrylonitrile butadiene rubber (HNBR) is useful. The liner can be bonded to the metal liner using a suitable adhesive, such as Chemlok 238 a butyl elastomer adhesive and Chemlok 205 a HNBR elastomer a primer sold by Lord Chemical Products. The use of the enhancement layer is preferred. Other enhancements layer known in the art can also be employed.

On the outer surface of the metal liner 34 is positioned reinforcing layer 38 of composite material or dry fiber laminate. The reinforcing layer can be applied as dry fiber laminates, that is fibers are spun around the line but are not adhered together with a binder resin or it can be applied as a typical composite layer, fiber laminate impregnated with resin or combinations thereof. The reinforcing layer will typically have multiple plies of fiber. When the fibers are impregnated with resin the reinforcing layer can be cured. The reinforcing layer can be adhesively bonded to the metal liner 34 if desired. The structure and dimensions of this reinforcing layer are determined taking into account expected pressures to be encountered in the use. The reinforcing layer is applied adjacent to the metal liner to provide sufficient strength to resist collapse if water or other fluid penetrates the outer composite layer, or if internal fluids leak through the liner. The reinforcing layer should be designed to provide sufficient hoop strength to avoid collapse from the expected ambient pressure extreme of use. Also, in a preferred embodiment, the fibers used are preferably those that do not cause a galvanic reaction with the metal liner.

Positioned over reinforcing layer 38 is shear ply layer 40. Shear ply layer 40 is of natural rubber layer, or modified natural rubber layer or other polymeric material. Hydrogenated acrylonitrile butadiene rubber (HNBR) is useful for the shear ply. The purpose of shear ply is to allow the outer layers to move separate from the layers inside the shear ply. Further, shear ply layer 40 also serves as a fluid tight barrier to prevent water from penetrating reinforcing layer 38 from the outside and serves as a seal to contain any internal leakage within the riser.

Positioned on the outer side of shear ply layer 40 is outer main structural layer 42 of composite material. Outer main layer 42 is made from a composite material with plies of fibers impregnated with a resin which has been cured. The design, orientation, and thickness of the various plies of composite fibers making up the outer main layer 42 is determined in accordance with the strength requirements to support the composite riser when it is installed in a string of risers connecting the sea floor to the surface. The outer main layer can be of any desired configuration and mixture of plies of various fibers. For example, a portion of the outer main layer can be a carbon fiber helical and hoop composite. The outer main layer 42 is preferably covered by fluid impregnable layer 44. Fluid impregnable layer 44 is made from any fluid impermeable material such as rubber or polymeric material. The same material as used for the shear ply can be used as the fluid impregnable layer. The purpose of layer 44 is to prevent water from impregnating the main outer layer 42. If fluid impregnable layer 44 was not present, water would flow through any cracks that develop in the resin bonding the fibers in the main outer structural layer and exert pressure against the shear ply and the layers inside the shear ply. If the reinforcing layer 38 were not provided that pressure could exceed the collapse strength of metal layer 34.

In a preferred embodiment, a scuff absorbing layer 46 is positioned over fluid impregnable layer 44. Thus, scuff absorbing layer 46 is designed to protect the fluid impermeable layer 44 to prevent cuts and gouges which would compromise the integrity of fluid impermeable layer 44. Scuff absorbing layer 46 is preferably made of a composite material. In a preferred embodiment, the scuff absorbing layer is a glass fiber composite.

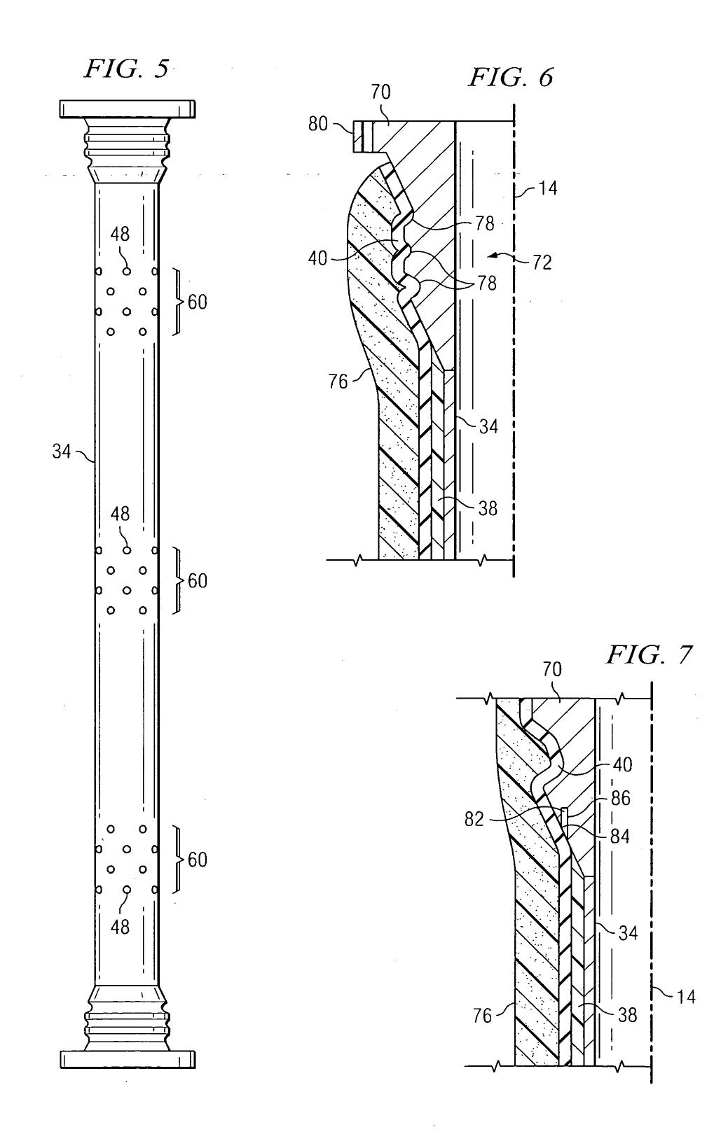

In a preferred embodiment, the metal liner has one or more engaging surfaces on the outside of the metal liner. These engaging surfaces improve the adhesion or engagement of the reinforcing layer 38 to the liner. FIGS. 3A-3D illustrate different types of engaging surfaces. Each figure illustrates a portion of the liner 34. In each illustration a different type of engaging surface is shown. In FIG. 3A a plurality of raised nubs 48 are provided. In FIG. 3B circumferential grooves 50 are provided. In FIG. 3C a spiral ridge is provided as the engaging surface. In FIG. 3D circumferential ridges 54 are provided. FIGS. 4A and 4B are cross-sectional views of liner 34 and illustrate yet other engaging surfaces. In FIG. 4A the engaging surfaces are one or more lateral grooves 56. In FIG. 4B the engaging surfaces are lateral ridges 58. As can be seen the engaging surface can be either a raised area or a depression on the outside surface of the liner. In this way some mechanical attachment of the reinforcing layer to the liner is provided. The engaging surfaces are useful when the reinforcing layer is of a dry fiber laminate which is not adhered to the liner. FIG. 5 illustrates the engaging surfaces, arranged in one or more engaging sections 60 rather than having engaging surfaces along the entire length of the riser. Other types of engaging surfaces can be utilized or a combination of engaging surfaces may be utilized.

FIG. 6 is a partial cross-sectional view of one embodiment of a composite riser of the present invention. In this cross-section there is the liner 34, attached to the metal composite interface 70. Covering the outside of the liner 34 is reinforcing layer 38 and in this embodiment the reinforcing layer also covers a portion of the metal composite interface 70. Over the top of the reinforcing layer is the shear ply layer 40 which also serves as a fluid seal. The shear ply layer 40 extends over the connecting surface 72 of the metal composite interface which in this illustration is a trap lock design. The outer layers 76 are not detailed but simply shown as the single unit in the drawing for convenience. The main outer body 76 which covers the shear ply layer 40 has a portion of the fibers embedded in the trap locks 78 to secure the outer composite layers to the metal composite interface 70. The outer layer does not cover the end of the metal composite interface so that flange 80 is exposed. Flange 80 includes holes 82 to receive bolts or other fasteners to connect separate risers together. Any other fastening mehcanisms can be used. This is a less preferred embodiment because of the possibility that water may be able to migrate between the shear ply layer 40 and metal composite interface 70 and then migrate to the reinforcing layer 38. A reinforcing layer 38 of composite material will typically contain cracks in the resin at elevated pressures, and thus the presence of water penetrating the reinforcement layer 38 in some instances could cause the metal liner 34 to separate from the reinforcing layer and collapse.

FIG. 7 shows a partial cross-sectional view of another embodiment of the present invention. In this embodiment, the metal composite interface 70 is provided with a groove 82 which is substantially parallel to the axis 14 of the riser. In this embodiment, the reinforcing layer 38 is covered by the shear ply layer 40; however, the end of the shear ply interfacing with the metal composite interface 70 has a seal section 84 which is generally Y-shaped that provides a pressure activated seal. In the event that water leaks between the end of shear ply layer 40 and the metal composite interface 70, the water will travel between the shear ply and a metal composite interface until it reaches the groove 82. When the water reaches the outer side of the groove 82 it will push the pressure activated sealing section 84 into contact with the inner surface 86 of the groove 82. Thus, a seal will be formed as a result of the pressure pushing the shear ply layer 40 against the inside surface 86 of the groove 40 preventing migration of the water beyond the sealing tab. In a similar manner, the seal will also prevent fluid that may leak through the liner and reinforcing layer from leaking from the composite riser.

The invention increases the reliability of the composite riser while minimizing weight. A composite riser constructed without the reinforcing layer would either provide a metal liner of sufficient strength to withstand the expected ambient pressure or would assume that the outer fluid impermeable layer would not be breached or compromised. The assumption that the outer fluid impermeable layer will not be breached is not a sound long term assumption in the commercial environment. Dimensioning the metal liner to resist the pressure has the disadvantage of sacrificing weight which is a primary advantage of the composite riser.

While the present invention has been described in relation to certain preferred embodiment, the description is not limiting of the invention and those skilled in the art will appreciate variations from the disclosed embodiments without departing from the nature of the invention.

1. A composite collapse resistant riser comprising:
a metal liner;
a reinforcing layer adjacent the outside of said liner;
a shear ply layer over said reinforcing layer; and
an outer main structural layer of composite material over said shear ply layer.

2. A riser of claim 1 wherein said reinforcing layer is selected from the group comprising dry fiber laminates, composite materials and combinations thereof.

3. A riser of claim 1 further comprising:
a performance enhancement layer on the inside of said liner.

4. A riser of claim 1 further comprising:
a fluid impermeable layer over said outer main layer of composite material.

5. A riser of claim 3 further comprising:
a scuff absorbing layer over said fluid impermeable layer.

6. A riser of claim 1 wherein said liner is selected from the group consisting of steel, aluminum and titanium.

7. A riser of claim 1 wherein said liner has at least one engaging surface on its outer surface.

8. A riser of claim 6 further comprising a performance enhancement layer on the inside surface of said layer.

9. A riser of claim 5 wherein said scuff absorbing layer is of composite material.

10. A composite collapse resistant riser comprising:
a riser core having a metal liner having a first end and a second end and metal composite interfaces positioned adjacent said first and second ends of said liner;
a reinforcing layer selected from the group consisting of dry fiber laminates, composite laminates and combinations thereof adjacent the outside of said liner;
a shear ply layer over said reinforcing layer; and
an outer main structural layer of composite material over at least of portion of said riser core and connected to each of said metal composite interfaces.

11. A riser of claim 10 further comprising:
a performance enhancement layer on the inside of said liner.

12. A riser of claim 10 further comprising:
a fluid impermeable layer over said outer main layer of composite material.

13. A riser of claim 12 further comprising:
a scuff absorbing layer over said fluid impermeable layer.

14. A riser of claim 11 wherein said metal liner is selected from the group consisting of titanium, aluminum and steel.

15. A riser of claim 13 wherein said metal liner is selected from the group consisting of titanium, aluminum and steel.

16. A riser of claim 10 wherein said metal liner has at least one engaging surface on its outer surface.

17. A riser of claim 13 wherein said metal liner has at least one engaging surface on its outer surface.

18. A riser of claim 10 further comprising at least one transition ring interposed between at least one of said metal liner and at least one of said metal composite interfaces.

19. A riser of claim 10 wherein said shear ply has a sealing section.

20. A riser of claim 13 wherein said shear ply has a sealing section.

21. A riser of claim 19 wherein said sealing section is a generally Y-shaped portion which is received in a groove of said metal composite interface.

22. A composite collapse resistant liner comprising:
a metal liner having a first end and second end;
a metal composite interface having one or more trap locks positioned at each end of said metal liner;
a reinforcing layer adjacent the outside of said liner;
a shear ply layer over said reinforcing layer; and
an outer main layer of composite material over said shear ply and engaging said trap locks.

23. A riser of claim 22 further comprising:
a performance enhancement layer on the inside of said metal liner.

24. A riser of claim 22 further comprising:
a fluid impermeable layer over said outer main layer of composite material.

25. A riser of claim 24 further comprising:
a scuff absorbing layer over said fluid impermeable layer.

26. A riser of claim 23 further comprising:
a fluid impermeable layer over said outer main layer of composite material.
